(19) United States
(12) Patent Application Publication
(10) Pub. No.: US 2004/0221011 A1
(43) Pub. Date: Nov. 4, 2004

(54) High volume electronic mail processing systems and methods having remote transmission capability

(76) Inventors: Steven Smith, San Francisco, CA (US); Douglas P. Rayner, San Francisco, CA (US); Joseph T. Kalash, Berkeley, CA (US); Randall J. Zach, Berkeley, CA (US); Kenneth A. Schmidt, San Fancisco, CA (US)

Correspondence Address: FLIESLER MEYER, LLP, FOUR EMBARCADERO CENTER, SUITE 400, SAN FRANCISCO, CA, 94111, US

(21) Appl. No.: 10/389,419

(22) Filed: Mar. 14, 2003

Related U.S. Application Data
(63) Continuation-in-part of application No. 09/829,524, filed on Apr. 9, 2001.
(60) Provisional application No. 60/196,223, filed on Apr. 10, 2000.

(51) Int. Cl. G06F 15/16

(52) U.S. Cl. 709/206

(57) ABSTRACT

High volume electronic mail messaging transfer systems and methods employ several groups of servers in order to more efficiently handle processing and transmission of messages to large numbers of recipients. A first group of servers designated as the A servers in the preferred exemplary embodiment provide storage for databases containing various electronic mail lists. These servers also preferably contain the majority of software which is used in manipulation and processing of messages for transmission to the recipients identified on the lists. A second class or group of servers referred to as the B servers is preferably employed under the control of the A servers. It is the B servers which actually perform mass delivery of the electronic mail messages. In a further preferred exemplary embodiment, yet another group of servers known as the C servers is used to collect bounced electronic mail messages and to provide this information to the A servers.

This patent application is a continuation-in-part of provisional application no. 60/196,223 filed on Apr. 10, 2000 and which is incorporated herein by reference. This application is also a continuation-in-part application of application Ser. No. 09/829,524 filed Apr. 9, 2001, titled: High Volume Electronic Mail Processing Systems And Methods, which is incorporated herein by reference.

### BACKGROUND OF THE INVENTION

1. Field of the Invention

The present invention relates generally to the field of electronic telecommunications systems and methods. More specifically, the present invention is directed to systems and methods for processing and transmitting extremely high volume electronic mail messages.

2. Description of the Related Art

Electronic mail messaging systems are well known and have rapidly become one of the most common means of communicating messages and transferring data. The vast majority of businesses and many individuals now use this mode of communication as one of their primary messaging systems. Electronic mail is both easy for individuals to use and makes use of many existing and readily available resources.

In these conventional systems, an electronic mail message is typically generated in a personal computer and the message along with any desired attached data files is then transferred through a computer network, such as, for example, the Internet. This form of messaging has reduced paper consumption while allowing a dramatic increase in the transfer of data among individuals. Electronic mail has proven to be a very efficient and convenient mechanism for communication. Most systems are extremely flexible and allow messages to be received from a variety of remote locations.

The rapid growth and popularity of electronic mail has also resulted in new uses for this form of communication. While originally electronic mail was primarily used for communicating between individuals or from corporations to their employees, this resource has now been adopted by other entities which have historically used more conventional modes of communication. For example, news sources and other entities which must communicate with extremely large numbers of people are now utilizing electronic mail as a means of communication and transferring data.

In order to accommodate these uses, conventional electronic mail handling systems have been required to handle message transmission to ever increasing numbers of recipients. This has resulted in the identification of a number of conventional system shortcomings and the recognition of the inability of these conventional systems to handle the transfer of electronic mail messages to mailing lists which may be as large as one million addresses or more.

Single machine electronic mailing system implementations have physical software and hardware limitations inherent in the systems which prevent these systems from quickly and efficiently processing very large lists. For example, these shortcomings include fundamental bandwidth limitations for the basic connections used by the systems, the processing speed of the microprocessor and the time required for executing system code. Conventional systems were simply not designed to handle the transfer of such large volumes of messages.

Single-machine systems have limited delivery performance for large lists fundamentally due to limitations of single-machine systems in terms of processing capacity, disk access capacity, and operating system limits (for example, such things as inodes, open file limits, open socket limits, etc.). Additionally, there are physical limitations on list size due to the inability to handle substantial numbers of transactions. For example, these limitations arise due to bounced messages, subscribe requests, removal requests, and user/delivery database queries associated with large lists. Furthermore, with single machine systems, there is a significant expense in light of the requirement for having high-reliability hardware (or redundant hardware) for the entire system due to the potential for single point of failure.

In addition to these deficiencies, existing electronic mail transfer systems are not able to utilize separate servers and systems for housing confidential data and performing mission critical tasks. It is desirable that these tasks be performed by high-end reliable and expensive machines. In contrast with these requirements, the delivery/return servers and systems can be multiple inexpensive servers housed at low-cost hosting providers or which are connected via low-cost connections. Accordingly, a substantial economic benefit can be realized by utilizing more expensive servers and systems for certain mission critical tasks and less expensive servers and systems for other less critical tasks.

Similarly, there are shortcomings in multiple-machine implementations, where an individual electronic mail list is partitioned for processing among multiple machines which then handle the partitioned list portions as separate lists. These types of implementations require significant complexity in administration, saving, uploading, querying, and setting up deliveries. There is a substantial manual effort in repartitioning lists as size and activity level changes among the various machines used for implementation. These implementations are typically inefficient due to the inherent underutilization of systems as size and activity levels change. Additionally there is a significant expense due to the requirement for high reliability hardware or redundant hardware due to the susceptibility to outages.

Finally, many conventional systems are unable to handle such a large volume of electronic mail messages due to the fact that the directory structures which are commonly utilized by operating systems simply become too large and unmanageable for these conventional systems. Operating systems typically limit the number of files that the system can handle. Furthermore, it becomes increasingly inefficient to access this information for each file. As a result of these and other shortcomings, conventional computer systems which are designed for processing and handling of electronic mail are simply incapable of handling and processing electronic mail messages where the messages are to be transferred to ever increasing numbers of recipients. Even in the handling of relatively shorter lists, efficiency is not optimized.

The inventor of the systems and methods disclosed herein have discovered solutions for overcoming the foregoing and other shortcomings of the existing electronic mail processing systems. Accordingly, one object and advantage of one aspect of the present invention is to provide systems and methods for handling and processing electronic mail messages where the number of recipients is extremely large. Another object and advantage of one aspect of the present invention is to provide systems and methods for handling processing of electronic mail messages which utilize existing hardware resources. Yet another object and advantage of one aspect of the present invention is to provide systems and methods for handling and processing of high volume electronic mail messages which are both scalable and easy to implement. Yet another object and advantage of one aspect of the present invention is to provide systems and methods for handling and processing high volume electronic mail messages which are extremely efficient. Other objects and advantages of the present invention will be apparent in light of the following Summary and Detailed Description of the presently preferred embodiments.

### SUMMARY OF THE INVENTION

The present invention is directed to systems and methods for handling and processing electronic mail messages which are to be transferred to an extremely large number of recipients. The systems and methods of the present invention are extremely robust and scalable and are easily capable of handling and processing electronic mail messages which are to be received by one million recipients or more.

In accordance with a first preferred exemplary embodiment of the present invention, high volume electronic mail messaging transfer systems and methods employ several groups of servers in order to more efficiently handle processing and transmission of messages to large numbers of recipients. A first group of servers designated as the A servers in the preferred exemplary embodiment provide storage for databases containing various electronic mail lists. These servers also preferably contain the majority of software which is used in manipulation and processing of messages for transmission to the recipients identified on the lists. For example, this software is capable of generating reports and controlling actual electronic mail delivery. The overall control software is described in more detail below.

A second class or group of servers referred to as the B servers is preferably employed under the control of the A servers. It is the B servers which actually perform mass delivery of the electronic mail messages. In a further preferred exemplary embodiment, yet another group of servers known as the C servers is used to collect bounced electronic mail messages and to provide this information to the A servers. In yet another alternate exemplary embodiment of the present invention, an additional group of servers is utilized to further distribute the tasks of the overall system. In this exemplary embodiment, a further separate group of servers is used to receive and process inbound requests to the system. For example, these requests may be made by individuals who interact with a website or otherwise request to be added to a particular mailing list. It is this additional group of servers, known as the D. servers which are utilized for handling and processing of inbound messages to the system.

The systems and methods of the present invention are extremely flexible and provide the ability to add multiple servers for each function thereby providing infinite scalability with respect to the number of lists which can be simultaneously processed and delivered by the system. The ability for a single mass mailing to utilize resources on several servers for several remote networks simultaneously provides the ability to deliver mail to extremely large lists of recipients in a very brief period of time. The systems and methods of the present invention are also very efficient and are capable of performing these tasks in a very short period of time, far faster than conventional systems utilizing the resources of a single server for performing these same tasks. It will be recognized by those skilled in the art that multiple system tasks may be handled by a single group of servers. However, in order to achieve maximum efficiency it is preferred that multiple groups of servers be utilized for performing dedicated tasks as mentioned above.

In a preferred exemplary embodiment of the system, a verification of processing is performed at intermediate stages to ensure complete recoverability from any stoppage in processing of electronic mail delivery by either the A or B servers. A substantial increase in efficiency is achieved through utilization of the systems and methods of the present invention. There is a reduction in the number of mail queue files required for large mailings by a factor of 100 or some other ratio. For example, a typical conventional mailing to one million recipients would require over 2 million queue files and over 20 GB of disk space. These advantages specifically apply to implementations where Sendmail is used as the mail transfer agent (MTA). They may also apply to other implementations as well where similar file structures are used. The systems and methods disclosed herein reduces the required number of queue files to approximately 20,000 and uses only 200 megabytes of disk storage based on systems utilizing a ratio of 100 to 1 for a comparable mailing. As noted above and described in more detail below, other ratios are possible as well.

Yet another advantage of the systems and methods of the present invention is that processing in this fashion is much more economical than through utilization of other systems. Specifically, for example, the redundant nature of the B and C servers allows the use of much less costly servers and connections in much the same way as a RAID array provides high reliability storage through the use of redundant lower-cost disks. The systems and methods disclosed herein provide high reliability delivery but also use lower cost servers for delivery and bounce processing thereby further enhancing the overall efficiency.

In the preferred exemplary embodiment, the system user schedules message transmission via a web-based interface. Based on user selections, the web based program places the message along with any preferences and schedule information in a pending message queue. This information may be stored on the A servers or in another memory associated with the A servers or which is otherwise accessible to the A server. The user can schedule delivery immediately or at some future point in time. This portion of the system operation is preferably performed via the A servers, however, those skilled in the art will appreciate that yet additional servers could be utilized for providing the fundamental user interface for scheduling the delivery of messages. The scheduling information need only be accessible to the A server or servers through which the message will be transmitted.

In the preferred exemplary embodiment, the system reviews the pending message queue periodically to identify messages to be sent by the system. If the system identifies a message in the pending message queue which is to be sent, a sender process is initiated. The sender process is preferably run by the A servers. In the preferred exemplary embodiment, the sender process first checks to see if this operation has been run before in order to avoid repetition of any steps which could result in duplicate or skipped deliveries. If this process has been run before, it will skip to the point in time at which it left off. If the system determines that this is the initial processing of the particular message, message delivery begins by partitioning the primary list of recipients into delivery list portions. The system also creates cross-reference files for mail merge. Once the delivery list portions have been created, the system then determines the number of Sendmail delivery processes required based on the target delivery time and the total number of recipients. Those skilled in the art will recognize that other MTA's may be utilized with the architectures of the present invention. When the total number of resources has been determined, each of the delivery lists are assigned to their respective B servers.

This is accomplished by identifying the list of available remote delivery B. servers. For each server in the list, the system checks to see if it has already allocated processes and started delivery through these servers. If this has not occurred, the system attempts to allocate processes by contacting the remote server and attempting to reserve as many possible processes. When processes have been successfully reserved, the reservations are recorded and a separate process is preferably created so that the file transfer and remote delivery steps can occur in parallel. This is preferably a forked process which also initiates remote delivery by transferring the corresponding delivery lists, the cross-reference files, message files, and the starting of the queuing and delivery process. A checkpoint is preferably saved after each of the steps on the remote servers as well so that if there is a process interruption, the system will be able to be restarted without causing duplicate messages or missed deliveries. It is the queuing portion of the process described above where only one message queue file is created per 100 addresses or some other ratio rather than one queue file for message as is common.

Significantly, it is important to recognize that the various database servers described above (the A servers) and the delivery and return processing servers (B and C servers) can be separate and physically located anywhere with access to the Internet. The same is also true of the inbound servers (the D servers). The important implications of this aspect of the design is that in the preferred exemplary embodiment, separate dedicated servers may be provided possibly even on site at a customer location thereby providing customers with the ability to house their own database or A servers in-house while using delivery and return processing servers of a mail processing service located physically at a different location. This is particularly desirable because the database servers which contain possibly proprietary information can be controlled more tightly by a customer utilizing the delivery service. Additionally, the customer is nevertheless able to make use of the high-volume, high performance network of delivery servers thereby eliminating the need for a significant internet connection.

In the preferred exemplary embodiment, during the same period of time that the forked process initiates the delivery process, the primary sender process continues to loop through each of the remote delivery servers that has been previously reserved. Once all of the necessary processes have been allocated, the remote delivery or B servers are periodically queried, preferably at regular intervals to verify progress and to restart any process that may have been interrupted.

Subsequent to file transfer and queuing, a process is initiated on the B servers which commences actual message delivery. This consists of forking and beginning simultaneous Sendmail processes. As noted, this may also be accomplished through simultaneous multiple delivery with other MTA's. The actual number of Sendmail processes is the number previously reserved by the sender process running on the A servers. Each individual Sendmail process reads the queued files in turn and for each queue file reads its corresponding delivery list and mail merge cross-reference. The original message is then sent to each address specified in the corresponding delivery list. Each delivered message is personalized with information contained in the mail merge cross-reference file. The main remote server process continues to run in parallel, periodically checking to make sure that the Sendmail processes are restarted if necessary in order to make sure that the complete delivery of all messages is achieved.

When the verification confirms that each of the remote delivery servers have completed their respective sending obligations, the A Server sends a delivery summary to the requestor and the sender process completes. It will be recognized by those skilled in the art that delivery summaries may be selectively sent at other times as well.

### BRIEF DESCRIPTION OF THE DRAWINGS

FIG. 1 is a block diagram illustration of a first exemplary embodiment of the present invention;

FIG. 2 is a block diagram illustration of an alternate exemplary embodiment of the present invention;

FIG. 3 is a block flow diagram illustration of an exemplary embodiment of the present invention;

FIG. 4 is a block flow diagram illustration of an exemplary embodiment of the present invention related to bounced message processing;

FIG. 5 is a block diagram illustration of an exemplary embodiment of the present invention wherein separate inbound servers are employed;

FIG. 6 is a block diagram illustration of an exemplary embodiment of the present invention which illustrates an exemplary embodiment where mailing lists are stored in storage systems other than the A servers;

FIG. 7 is a block flow diagram illustration of an exemplary embodiment of the present invention;

FIG. 8 is a block flow diagram illustration of an exemplary embodiment of the present invention;

FIG. 9A is a block flow diagram illustration of an exemplary embodiment of the present invention;

FIG. 9B is a block flow diagram illustration of an exemplary embodiment of the present invention;

FIG. 9C is a block flow diagram illustration of an exemplary embodiment of the present invention.

FIG. 10 illustrates an alternate system configuration;

FIG. 11 illustrates yet another alternate system configuration; and

FIG. 12 illustrates yet another alternate system configuration.

### DETAILED DESCRIPTION OF THE PRESENTLY PREFERRED EMBODIMENTS

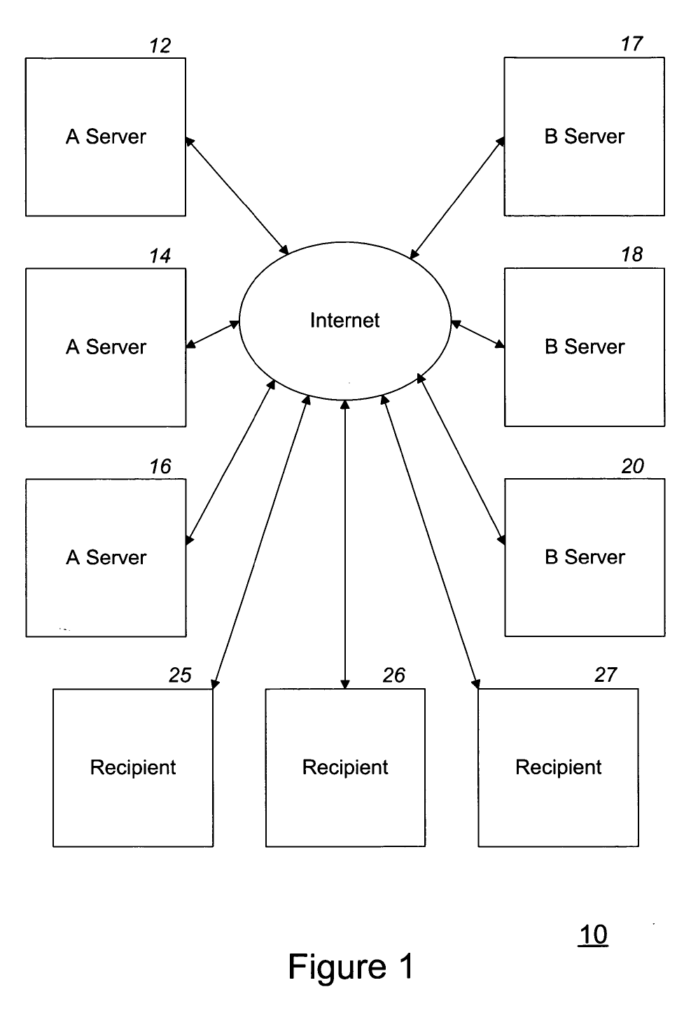

A first exemplary embodiment of the present invention is shown generally at 10 in FIG. 1. In accordance with this exemplary embodiment of the present invention, high volume electronic mail messaging transfer systems and methods employ several groups of servers in order to more efficiently handle processing and transmission of electronic mail messages to large numbers of recipients.

As shown in FIG. 1, a first plurality of servers referenced as the A servers 12, 14, 16 are linked via the internet with a second plurality of servers. The first group of servers designated as the A servers in the preferred exemplary embodiment provide storage for databases containing various electronic mail lists. These servers also preferably contain the majority of software which is used in manipulation and processing of messages for transmission to the recipients identified on the lists. For example, this software is capable of generating reports and controlling actual electronic mail delivery. The overall control software is described in more detail below.

The second group of servers to which the A servers are connected via the internet are designated as the B servers or delivery servers. 16, 18, 20. The second class or group of servers referred to as the B servers is preferably employed under the control of the A servers. It is the B servers which actually perform mass delivery of the electronic mail messages to the ultimate recipients 25,26,27. It should be recognized that the embodiments set forth herein are exemplary only and that many variations of the structures set forth herein may be employed but which still utilize the teachings of the present invention. For example, although the exemplary embodiments indicate that there are a plurality of A servers, it is possible that a single A server will be utilized in conjunction with a single B or delivery server. Furthermore, as noted in more detail below, the primary A server or servers could alternately be embodied as a single computer with access to the list information. Specifically, for example, the list information could be accessible to an A server through the internet or via a direct connection. All that is necessary is that the A server have access to the list information so that the appropriate lists can be transferred by the system to the B servers at the appropriate time. The details of the delivery protocols are set forth below.

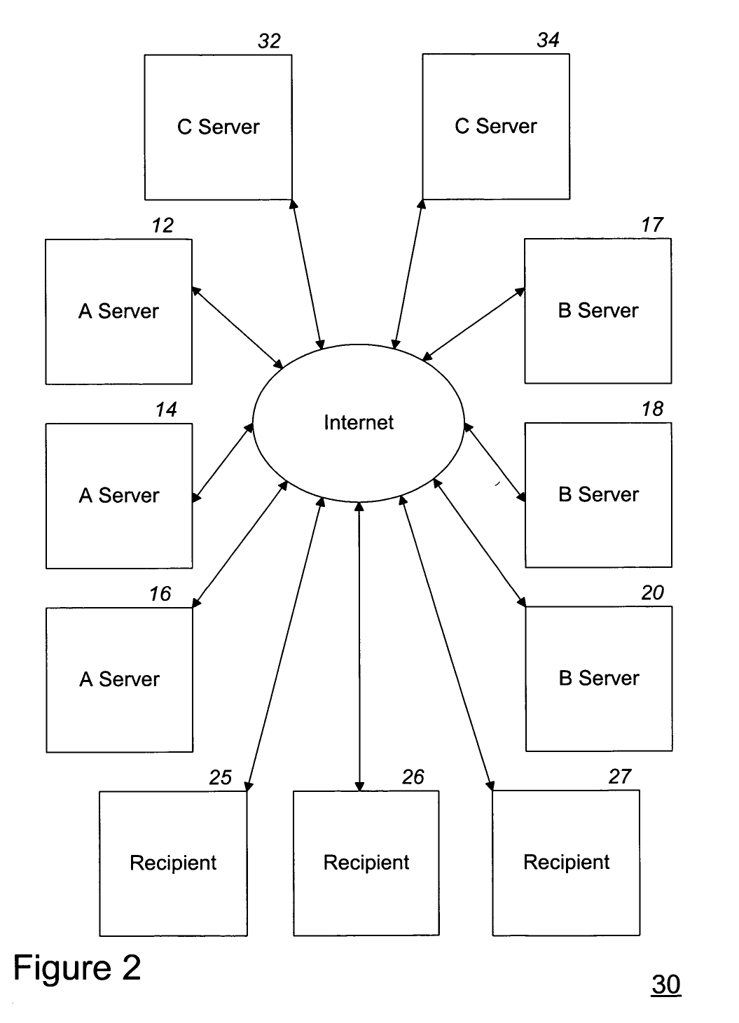

FIG. 2 illustrates an alternate exemplary embodiment of the invention which is shown generally at 30. This alternate embodiment of the invention employs yet another group of servers known as the C servers 32, 34 which are used to collect any bounced electronic mail messages and to provide this information to the A servers. The remaining portions of the system are similar to those described above and employ identical reference designations for convenience.

The systems and methods of the present invention are extremely flexible and provide the ability to add multiple servers for each function or distinct group thereby providing virtually infinite scalability with respect to the number of lists which can be simultaneously processed and delivered by the system. The ability for a single mass mailing to utilize resources on several servers from several remote networks simultaneously provides the ability to deliver mail to extremely large lists of recipients in a very brief period of time. The systems and methods of the present invention are also very efficient and are capable of performing these tasks in a very short period of time, far faster than conventional systems utilizing the resources of a single server for performing these same tasks.

In a preferred exemplary embodiment of the system, verification of processing is performed at intermediate stages of the message transmission in order to ensure complete recoverability from any stoppage in processing of electronic mail delivery by either the A or B servers.

As noted above, a substantial increases in efficiency is achieved through utilization of the systems and methods of the present invention. There is a significant reduction in the number of mail queue files required for large mailings by a factor of 100 or some other ratio. For example, a typical conventional mailing to one million recipients would require over 2 million queue files and over 20 GB of disk space. The systems and methods disclosed herein reduces the required number of queue files to approximately 20,000 and uses only 200 megabytes of disk storage based on systems utilizing a ratio of 100 to 1 for a comparable mailing. As noted above and described in more detail below, other ratios are possible as well.

Yet another advantage of the systems and methods of the present invention is that processing in this fashion is much more economical than through utilization of other available systems. Specifically, for example, the redundant nature of the B and C servers allows the use of much less costly servers and connections in much the same way as a RAID array provides high reliability storage through the use of redundant lower-cost disks. The systems and methods disclosed herein provide high reliability delivery but also use lower cost servers for delivery and bounce processing thereby further enhancing the overall efficiency.

In the preferred exemplary embodiment, the system user schedules message transmission via a web-based interface. This is where the A server 12, 14 etc. which is running the system is located at a site apart from the customer location. As detailed below, it is also contemplated that the A server or server could be located at a client location. In such an alternate embodiment, the use of the web interface is unnecessary and direct access to the machine may be utilized to begin the delivery process. The A servers can physically be located virtually anywhere and may be individually utilized for controlling the processing and transmission of one or several electronic mailing lists.

Furthermore, it will be recognized that the web interface is unnecessary in other implementations where a client controls sending of mail to one or more lists of recipients. In such alternate embodiments, initiation of the sending process may be accomplished via electronic mail commands, voice commands received by an automated system for converting the speech, verbal interaction with a person physically near the A server or any other electronic remote access protocol.

Based on user selections, in the preferred exemplary embodiment, the web based program places the desired message to be transmitted along with any preferences and schedule information in a pending message queue file. This information may be stored on the A server or in another memory associated with the A servers or which is otherwise accessible to the A server. The same is also true of the basic list data. Specifically, the mailing list or lists actually may be stored on a separate database which is simply accessible to the A server. The user can schedule delivery immediately or at some future point in time. This portion of the system operation is preferably performed via the A servers, however, those skilled in the art will appreciate that yet additional servers could be utilized for providing the fundamental user interface for scheduling the delivery of messages. The scheduling information need only be accessible to the A server or servers through which the message will be transmitted.

In the preferred exemplary embodiments illustrated in FIGS. 1 and 2, the A server 12 reviews the pending message queue periodically to identify messages to be sent by the system. If the system identifies a message in the pending message queue which is to be sent, a sender process is initiated for that message. The sender process is preferably run by the A servers 12, 14. In the preferred exemplary embodiment, the sender process first checks to see if this operation has been run before in order to avoid repetition of any steps which could result in duplicate or skipped deliveries.

If this process has been run before, it will skip to the point in time at which it left off previously. This is possible through the use of process completion checkpoints described in more detail below. If the system determines that this is the initial processing of the particular message. message delivery begins by partitioning the primary list of recipients into delivery list portions. It should be recognized that the system could also maintain the delivery list in delivery list portions stored in a memory associated with or otherwise accessible to the A servers 12, 14. The system also creates cross-reference files for mail merge at this time. Once the delivery list portions have been created, the system then determines the number of Sendmail delivery processes required based on the target delivery time and the total number of recipients. Obviously, as noted above, where an MTA other than Sendmail is utilized, the system monitors the concurrent parallel delivery of the particular MTA which is being utilized. When the total number of processes or the corresponding allocation of resources has been determined, each of the delivery lists are assigned to their respective B servers.

This is accomplished by identifying the list of available remote delivery B. servers. For each server in the list, the system checks to see if it has already allocated processes and started delivery through these servers. This is also accomplished through the use of the checkpoint feature. If this has not occurred, the system attempts to allocate processes by contacting the remote server B server to which the particular list portion is assigned and attempting to reserve as many possible processes. When processes have been successfully reserved on one or more B servers, the reservations are recorded and a separate process is preferably created so that the file transfer and remote delivery steps can occur in parallel.

This is therefore preferably a forked process which also initiates remote delivery by transferring the corresponding delivery lists, the cross-reference files, message files, and the starting of the queuing and delivery process. A checkpoint is preferably saved after each of the steps on the remote servers as well so that if there is a process interruption, the system will be able to be restarted without causing duplicate messages or missed deliveries.

Specifically, for example, the checkpoint feature could be accomplished through storing in a memory associated with or otherwise accessible to the appropriate B server information which identifies completed processes or portions of processes so that redundant steps or transmissions can be avoided.

Significantly, it is important to recognize that the various database servers described above (the A servers) 12, 14, etc. and the delivery and return processing servers (B and C servers) can be separate and physically located anywhere with access to the Internet. The important implications of this aspect of the designs of the present invention is that in the preferred exemplary embodiment, separate dedicated servers may be provided possibly even on site at a customer location thereby providing customers with the ability to house their own database or A servers in-house while using delivery and return processing servers of a mail processing service located physically at a different location. This is particularly desirable because the database servers which contain possibly proprietary information can be controlled more tightly by a customer utilizing the delivery service. Additionally, the customer is nevertheless able to make use of the high-volume, high performance network of delivery servers thereby eliminating the need for a significant internet connection at the customer location.

In the preferred exemplary embodiment, during the same period of time that the forked process initiates the delivery process, the primary sender process continues to loop through each of the remote delivery servers that has been previously reserved. It will be recognized by those skilled in the art that a forked process is not necessary in order to accomplish the parallel processing described herein. For example, any other programming construct which enables parallel operation will be suitable. Specifically, multithreading, separate individual processes or other developments may be utilized as well. Once all of the necessary processes have been allocated, the remote delivery or B servers are periodically queried, preferably at regular intervals to verify progress and to restart any process that may have been interrupted. Progress is verified by reviewing checkpoint information in order to ensure that progress is being made by each of the B servers. As noted above, this is accomplished by a review of the checkpoint information that is stored in the memory associated with the corresponding B server. If the A server or primary process receives an indication from a B server that no progress is being made, it will send a request to the B server to begin the process again at the location of the most recently completed checkpoint. For example, checkpoints may be identified as portions of the message list or lists that have been transmitted by the B server. If this polling of the B server progress indicates that the same checkpoint has been returned as the most-recent process completion point, the system will then request that the process be restarted at the most-recently completed checkpoint.

Subsequent to file transfer and queuing by the A server, a process is initiated on the B servers which commences actual message delivery to the recipients. This consists of forking and beginning simultaneous Sendmail processes on the respective B servers. The actual number of Sendmail processes is the number previously reserved by the sender process running on the A servers or other machine which has requested transmission by the B servers. Each individual Sendmail process reads the queued files in turn and for each queue file reads its corresponding delivery list and mail merge cross-reference. The original message is then sent to each address specified in the corresponding delivery list. Each delivered message is personalized with information contained in the mail merge cross-reference file.

For example, in an exemplary embodiment of the system, the partitioned mailing lists are preferably segmented into list portions that will each respectively contain certain similar content in order to streamline the mail merge process. This further increases the efficiency of the system. Specifically, in a mailing for news information, those members of an overall list who have requested to receive sports information will be separated into a corresponding list portion.

The main remote server process operating on the A server 12, 14 continues to run in parallel, periodically checking to make sure that the Sendmail processes running on the corresponding B servers are restarted if necessary in order to make sure that the complete delivery of all messages is achieved. In an alternate exemplary embodiment, when there is a failure of one or more of the B servers, the A server will dynamically reallocate the particular tasks assigned to the failed B server by determining if another B server is available subsequent to the failure. This may be done by making a general request for resources or alternatively, the a server may make a specific request to a particular B server that has already completed its tasks.

When the process verification step confirms that each of the remote delivery B servers have completed their sending responsibilities, the system sends a delivery summary to the requestor and the sender process operating on the A server completes. The process is repeated for any other lists which have been set for delivery and for which the delivery initiation time has been reached.

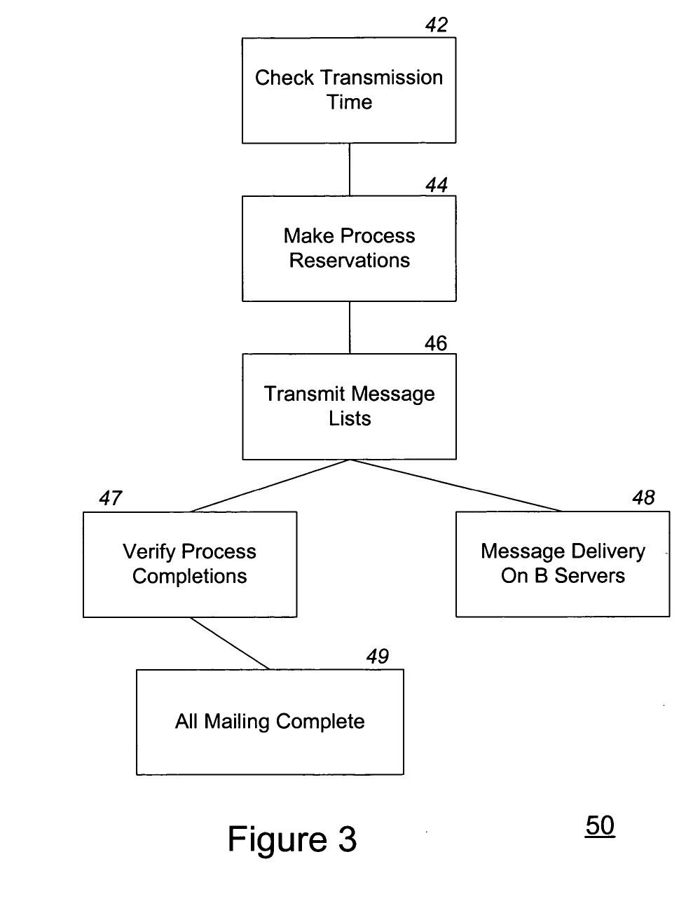

FIG. 3 is a block flow diagram illustration of the sending process for an exemplary embodiment of the present invention which is shown generally at 50. In a first step 42, the system checks to determine if the time for initiating transmission of a message list has expired. In step 44, the primary controller process makes the appropriate process reservations on any available B servers for transmission of the message to recipients. Next in step 46, message lists are transmitted from the A server to one or more B servers on which process reservations have been made. Thereafter, steps 47 and 48 operate in parallel. Step 47 is the primary process which continues and verifies that the Sendmail processes that have been initiated in step 48 on the B servers are progressing. Step 48 indicates initiation of the Sendmail processes on the B servers which perform the actual transmission of the messages and mail merge through implementation of Sendmail processes. Step 49 indicates that the primary process has verified completion of mail transmission to all recipients on the main list.

As noted above, it is contemplated that a separate computer other than a server which contains the mailing list information could control the primary process. In such an embodiment, the machine need only have access to the list information so that this separate machine can transmit the appropriate list information to the B servers that will be utilized based on confirmation of the availability of these machines. In an alternate embodiment, it is contemplated that the machine controlling the processing of the mailing by the B servers need not have direct access to the list information. In such an embodiment, the machine controlling the primary mail transmission process need only transmit list source information to each of the participating B servers so that the B server or servers are able to access the necessary list information. Specifically, for example, in such an alternate exemplary embodiment, the primary process controller need only transmit an identification of one or more storage locations where the appropriate address information can be accessed by the B server or servers. For example, this information could be located at a secure web site of a customer and the process operating on the controlling machine would simply transmit information to the B server so that the appropriate B server would be able to access the necessary address information.

In yet another alternate exemplary embodiment, the B servers retain list information in order to avoid the need to transmit the list information from the A server or other machine controlling the mail process. In such an alternate exemplary embodiment, the B server could acquire the appropriate list information in any of the ways identified above. For example either directly or through an indication of the appropriate storage location information. The controlling machine in such an embodiment would simply perform such tasks as initiation of the overall process and message transmission completion verification.

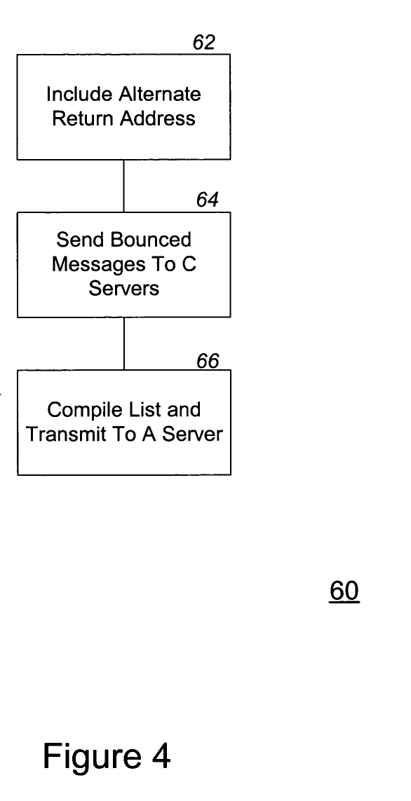

FIG. 4 is a block flow diagram illustration of an exemplary embodiment of the present invention shown generally at 60 which describes processing of bounced messages by the C servers. In such an embodiment, messages transmitted by the systems and methods of the present invention include return address information for another server location other than the network address of the actual machine transmitting the message. The inclusion of this alternate return address location is identified in step 62. In step 64 return or bounced messages are sent to the designated C server. This decreases the load on the actual server performing the transmission of the mail message as the machine is not required to process any bounced or returned messages for which the transmission address was not valid.

In step 66, the C server compiles the list of addresses for returned messages. The A server periodically requests this information. In an alternate embodiment, the C server transmits this information to the appropriate A server periodically. The A server then makes any necessary modifications to the lists which are handled by the system. For example, message transmission that has been rejected after one or more designated attempts will result in purging of the address from the mailing list. Additionally, those messages for which a reply has been sent that includes the term delete or any other predesignated reference will also result in deletion of the address from the mailing list.

It will be recognized by those skilled in the art that although the preferred exemplary embodiment of the invention described with reference to FIG. 2 indicates that a third group or class of servers known as the C servers is to be employed for the handling of bounced or returned mail, in alternate embodiments, either the B servers, the A servers or other system controlling machines could also be designated for return mail processing.

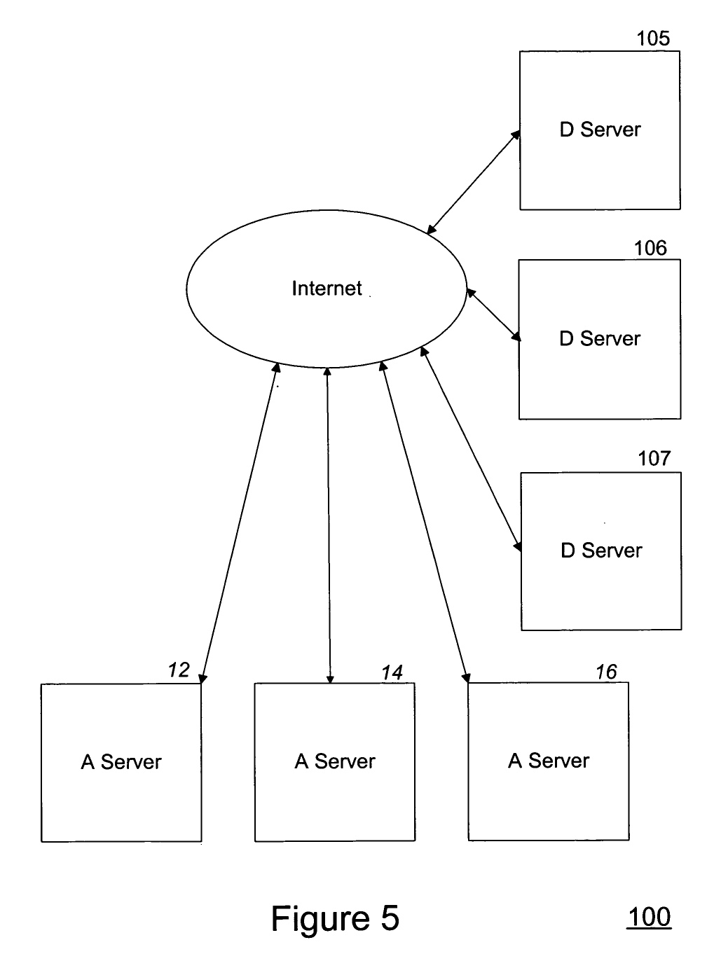

FIG. 5 illustrates yet another alternate exemplary embodiment of present invention which includes yet another group of servers, known as the D servers. The D servers are responsible for separately handling inbound requests to the system. For example, inbound requests include such things as customer requests to add or delete recipients to/from the list. Additionally, these servers handle requests from recipients for deletions and/or additions to the list. In the preferred exemplary embodiment, one or more D servers includes a memory or data buffer for storing inbound requests to the system for additions and/or deletions for the lists. The use of the D servers further enhances system efficiency by allowing inbound requests for changes in the lists to be initially handled by a separate group or class of servers. Specifically, the use of the separate servers for performing this task allows inbound requests to be processed without interruption of any processes being performed on other servers.

As shown in FIG. 5, a system which incorporates a separate group servers for handling processing of inbound requests for changes to the mailing lists is shown generally at 100. One or more inbound message processing servers 105, 106, 107 are capable of receiving inbound messages from both clients and list recipients or other individuals and entities. Advantageously, the separate inbound servers 105,106, 107 receive and compile messages which request additions and/or deletions from mailing lists. The additional inbound servers are configured to transmit any received requests for additions and/or deletions for the lists to the appropriate A server. Thus requests for additions and/or deletions can accumulate over a period of time so that they may be transmitted in bulk to the appropriate A server.

In the preferred embodiment, in order to facilitate improved access and to simplify interaction, the D servers can receive Web based requests, automatically process electronic mail requests, receive and process voice requests which are converted to text through speech recognition software or any other type of automated interaction. The D servers are also configured to automatically send confirmation of received requests. By allocating these tasks to the D servers, there is a significant economic advantage as the bandwidth dedicated these tasks need not be allocated to the A servers. Specifically, the D servers may be connected to the Internet through a significantly less expensive pipeline due to architecture considerations because they may be of a redundant design. The transmission tasks performed by the A servers may be sent to a more robust and more expensive pipeline. Furthermore there is less drain on the A servers.

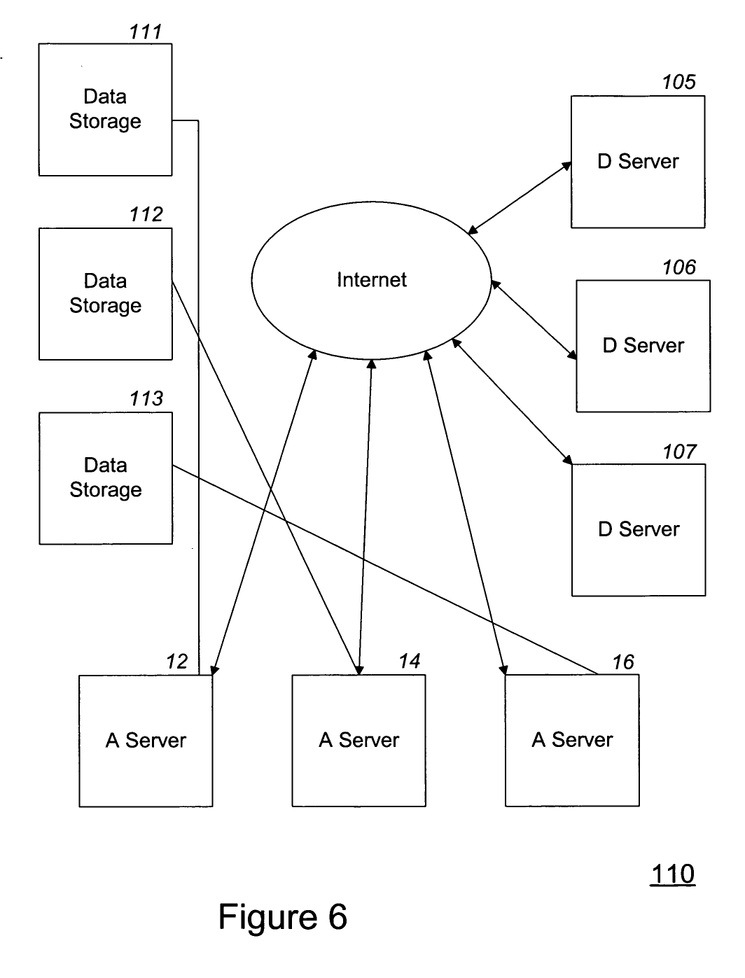

FIG. 6 illustrates yet another alternate preferred embodiment of present invention which is shown generally at 1 10. FIG. 6 is similar to the embodiments previously described with reference to the preceding figures, however, this diagram specifically illustrates the use of alternate storage mechanisms for housing information required for operation of the system. In particular, as shown in FIG. 6, each of the A. servers, 12, 14, 16 is further connected to yet another alternate database server 111, 112, 113 or other memory within which the mailing lists are maintained. The database servers 111, 112, 113 may be embodied as any known or developed memory architecture such as, for example, hard drives, CD-ROMs or semiconductor memory. In the preferred exemplary embodiment, the storage mechanisms are embodied as further database servers. This architecture for the system adds yet further flexibility and efficiency to the system.

Specifically, because the mailing lists are located on one or more separate servers, there is a further reduction in the drain on the system resources of the A. servers. In such an embodiment, the A. servers may be dedicated to processing of the overall distribution program. Other tasks relating to updating of the database information such as, for example, additions and deletions to the mailing lists may be handled by yet another computer with access to the database memory or the additional database servers 111, 112, 113. This same alternate architecture for improved efficiency and distribution of resources may be applied to the other servers previously described herein. In particular, information which is utilized by or otherwise manipulated by the remaining servers may also be stored in yet further database servers or memories in order to further decrease the drain on the resources of the particular server.

Although FIG. 6 illustrates a single connection and direct correspondence between the data storage elements 111, 112, 113, and the A storage units, it is contemplated that in an alternate embodiment a single commercially available database will be utilized by the system for storage of the mailing list information and the various A, B, C, and D machines will have access to the data and will be able to selectively modify this list information. Obviously, other variations on this technology are possible as well. Specifically, only certain machines may be linked directly with the list information and others will be required to transmit requests to change the underlying list information through other machines in the system.

For example, the D servers which are primarily responsible for processing of inbound requests to the system may employ additional servers or memory for storage or buffering of any accumulated mailing list changes. The D servers would, however, still be responsible for processing of the initial request for changes in the lists and creating additions to and deletions from the buffer of stored changes.

A specific example of the increased efficiency achieved by utilization of separate database servers for storage of the primary mailing lists is that the A servers would not be required to interact with the D servers or any other server in order to insure that requested additions and/or deletions from the lists would be made. In particular, in such an embodiment, the D servers would periodically directly transmit the buffered changes in the list to the appropriate additional server 111, 112, or 113 having the responsibility of storing the primary mailing list information. Alternatively, the server or other memory 111, 112, 113 having responsibility for storing the mailing list information would periodically request this change information directly from the appropriate D server, or as noted from another memory associated with the inbound D server. The utilization of these additional memories or servers further improves the efficiency and capacity of the overall system.

As noted, although FIG. 6 merely illustrates the A servers having direct access to these additional servers 111, 112, 113 it is contemplated that in an alternate architecture, where a single set of additional servers are utilized, more than one or even all of the different A. B. C. and D servers would be directly linked with the additional servers 111, 112, 113. This alternate system architecture further increases the flexibility and efficiency of the system. For example, where all of the A B C and D. servers are directly or indirectly connected to the servers housing the primary mailing list data, updates to the list could be made directly by either the C or D servers. Alternatively, as noted, the server or memory housing the relevant list information can be programmed to periodically actively request information from the C or D server or both.

It is further contemplated, that when using the architecture of FIG. 6, access to the mailing list information stored in the additional servers 111, 112, or 113 would also be provided to customers or other individuals for manipulation of the mailing list data. Limited access to the servers housing the mailing list information would be provided through known secure communication links in order to prevent unauthorized access or compromise of lists.

In a further alternate embodiment of present invention, further efficiency and system improvement is achieved through selective location of one or more of the servers or groups of servers described in architectures of present invention. Specifically, efficiency of the system is improved, for example, through the selective location of the B servers. The selective location that is referenced is the relative network location of the B server and/or the relative geographic location. The selective location of the B. servers is then utilized in conjunction with selective list partitioning in order to take advantage of the relative network or geographic location of the particular B. server or servers responsible for list delivery. This arrangement can be utilized in order to further improve efficiency of the overall system.

For example, in one exemplary embodiment, where it is known that a substantial number of list members is located within a given network, for example, the AOL network, the mailing list would be partitioned, once the delivery resources have been identified in order to take advantage of this known system characteristic. Specifically, where it is known that one of the B. or delivery servers is located within this particular network i.e., the AOL network, then that portion of the list containing addresses for delivery within this network would be handled by the specific B server or servers located within the AOL network.

In the preferred exemplary embodiment, the system is designed such that during the list partitioning process, those addresses which are within a common network are preferably located within a portion of the list dedicated to addressees of this common network. Specifically, when a master list is partitioned, AOL addresses would at least primarily be in a single portion of the list and AT&T addresses would preferably be at least primarily in another portion of the list etc.

In an alternate exemplary embodiment of the present invention, the B or delivery servers are preferably physically located in disparate geographic regions of the country. For example, one delivery server would be located on the East Coast, another in the Southeast, a third in the Midwest, a fourth in Southern California and the fifth in Northern California. Although each of the server locations have been described as being a single server, it is contemplated that actually multiple servers will be present at each geographic location. The system would then operate as described above wherein large mailing lists are partitioned for delivery by a plurality of delivery or B servers.

In this exemplary embodiment of the invention, the partitioning of the lists is done such that the overall system achieves further improvements in efficiency. This is accomplished by monitoring the number of network hops and/or the time delay from the B server responsible for delivering a particular message to receive server to which a given recipient's electronic mail is directed. In particular, trace route and ping commands may be utilized to derive this information. A database is then maintained which contains information on the number of network hops and/or the time delay from the actual delivery server to the recipient server. Data is then archived relating to the number of hops and/or time delay required for delivery for each recipient on the list. In the preferred exemplary embodiment, data is acquired in maintained regarding each recipient and the amount of time and/or network hops required for delivery by each of the delivery or B servers.

After several messages have been sent to each of the recipients from each of the delivery servers or at least several of the delivery servers, it is possible to identify certain delivery servers which are preferred due to the fact that there are able to deliver a message in less time and/or with fewer network hops. This may be a function of the relative geographic location of the delivery servers with respect to the recipient's mail server and/or the relative network positions of these servers.

For subsequent list partitioning, certain geographic locations of the delivery server for this particular recipient would either be designated as desirable or undesirable or acceptable/unacceptable. It will be recognized that these categorizations are exemplary only and the information may be generally utilized as a guide for identifying the preferred delivery server for particular recipient. As a result, for future deliveries of electronic mail messages, it is possible to selectively partition the list such that the overall system is able to take advantage of the distributed processing power of multiple delivery servers while also ensuring that the actual delivery server provides certain advantages over a randomly selected delivery server.

In the preferred exemplary embodiment, the portion of the program which acquires the data relating to preferred delivery servers is only periodically performed so that delivery times remain unaffected but the data may nonetheless the accumulated. This is preferred so that system performance does not deteriorate at the expense of acquiring this information.

In yet another further alternate embodiment of the present invention, once one or more of the delivery or B servers have indicated that they have available resources for processing of delivery requests, the B server or servers are programmed to actively seek the portion of the electronic mail list for which they are responsible for delivery. Specifically, in this embodiment of the present invention, the A servers or primary program execution servers still initiate delivery and identify the delivery servers with resources available for execution of delivery. This embodiment differs in that the A servers are no longer responsible for partitioning of the lists and transfer of the partitioned lists to the appropriate B servers. Rather, in this embodiment, when the B server has indicated that it has available resources, the B server then acquires one or more portions of the list for delivery. This can be accomplished in a variety of different ways.

For example, when a B server indicates that it has available resources, the B server may automatically acquire one or more data files containing one or more list portions for delivery. The size of the list portions acquired by the B server may depend on its current relative load or some other system parameter. For example, this may be dependent upon the relative resources available for this particular server and those available resources from other delivery servers. As noted above, the B server may request list portions from the A servers or alternatively, the B servers may request the list portion data from additional servers or memory associated with the system. Once this data is acquired, delivery continues as described above. In such an embodiment, the A server may be utilized to ensure that all portions of the overall list have been delivered or have delivery resources assigned for delivery.

The protocol for assigning or correlating delivery responsibilities for portions of the list with available delivery resources or processes is essentially the same regardless of whether the A Server makes the assignment of resources or the B server makes requests for data or list portions for delivery. There is preferably a balance between all available resources and the amount of the deliveries which the system is required to make.

For example, if there are 200,000 recipients for a given mailing list, and five delivery machines or B servers having equal available resources or processes, then the mailing for delivery responsibilities will be substantially equally distributed among the available machines, approximately 40,000 recipients to be processed by each delivery server. It should be recognized that the assignment of delivery responsibilities to available resources or processes does not need to be identically balanced or equal. For example, in the embodiment of the system where B servers take an active role in acquiring one or more portions of the mailing list, the amount of the list or the number of list portions acquired by a particular B server may be set to a predetermined value based upon its availability of resources or processes. Specifically, for example, at one level of availability it will seek out one list portion having 10,000 recipients in the list. If additional resources are available at the server then it will actively request another portion of the list. The system is programmed such that each B server with available resources or processes will acquire one or more portions of the list such that the number or size of the portions of the mailing list acquired by the particular B server correlates with the amount of resources available at the particular server.

In the version of the system where the B servers are responsible for acquiring one or more mailing list portions for delivery, it is preferred that the A servers still maintain the responsibility of ensuring that each of the B servers charged with delivery responsibilities actually completes delivery of the list portion or portions assigned to the server. This ensures that even when a B server hangs during processing, delivery will be completed. If the B server fails during delivery, the A server ensures that delivery of a complete list is accomplished.

In a further refined exemplary embodiment of the system, the A server or other server or memory within which one or more primary mailing lists are stored is automatically updated with information from both bounced messages acquired by the C servers and stored therein or in another memory associated with the C servers as well as information relating to inbound requests for additions and or deletions from the lists acquired by the D servers and stored therein or in another memory associated with the server. This is accomplished by a computer program which periodically requests this information or has access to a memory within which this data may be contained. The program then accesses the database containing the list for which a change is to be made. Thereafter the computer program interacts with the database in orders to make the appropriate additions and/or deletions from the list. For bounced message processing, the system may be configured in order to delete messages which have bounced a single time or more than one time. Specifically, for example it may be desirable to delete bounced messages only after they have bounced more than one time in order to ensure that desired recipients are not inadvertently deleted.

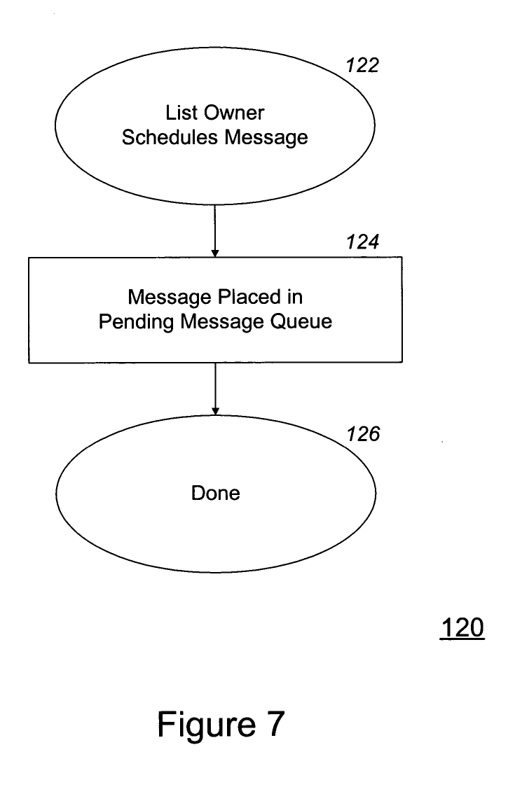

FIG. 7 is a first flow diagram indicating a general overall process in accordance with the systems and methods of the present invention which is shown generally at 120. In a first step 122, the list owner or client schedules an electronic mail message list for delivery. In step 124, the system indicates that the message is to be transmitted by placing the message in the pending message queue. This portion of the process is then completed in step 126.

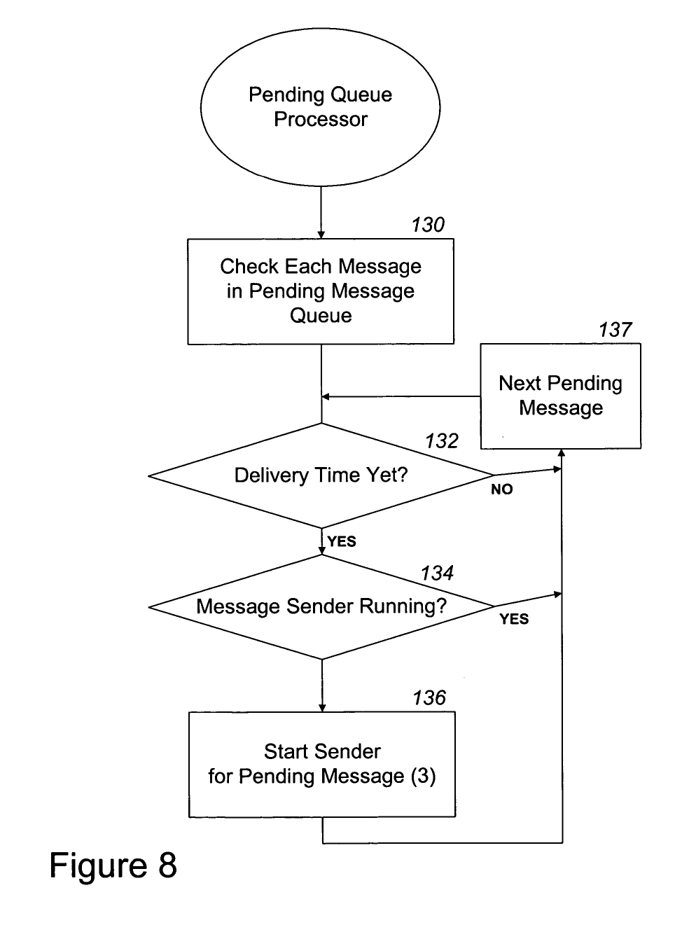

FIG. 8 illustrates the portion of the system which monitors the pending message queue. In step 130 the system checks each message in the pending message queue to verify whether or not its delivery time has expired. In step 132 if the delivery time has not expired the system then reviews the delivery time of the next message in the pending message queue. If the delivery time has expired, the system then verifies whether the message sender is running for that particular message in step 134. If the message sender is already running then the system reviews the next message in the pending message queue. If the message sender is not running for a particular message for which delivery time has expired the system then starts the sender process in step 136. Step 137 simply illustrates skipping to the next message in the pending message queue. It should be recognized that initiation of the mailing process may not rely on the pending message queue as a specific command or other instruction may be utilized.

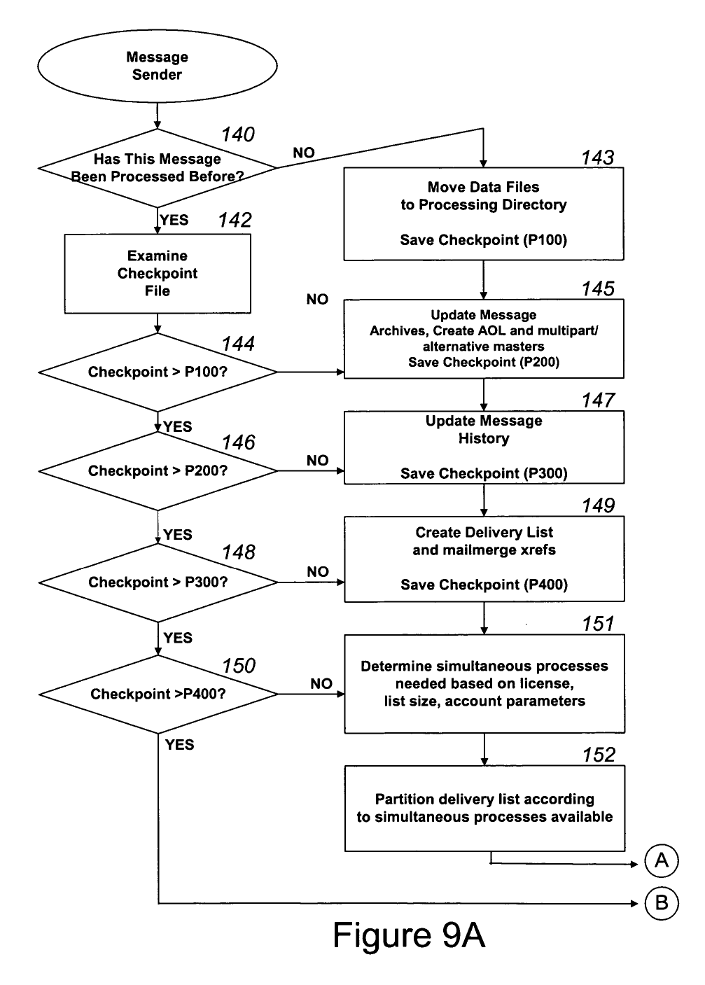

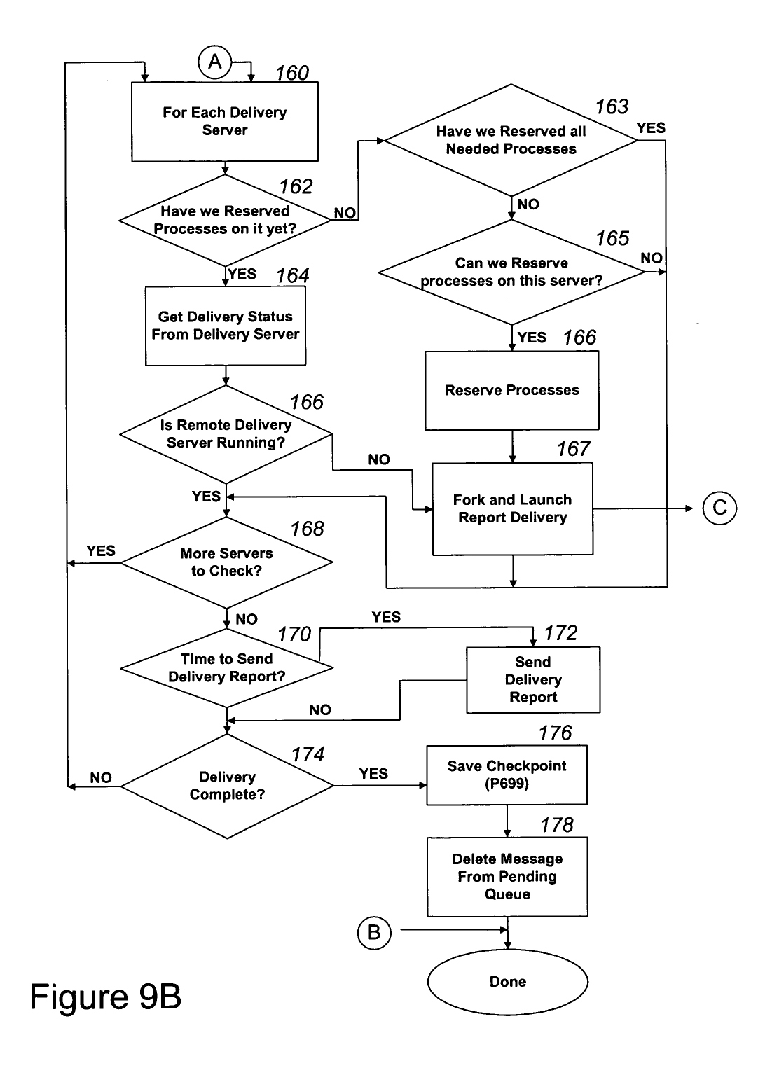

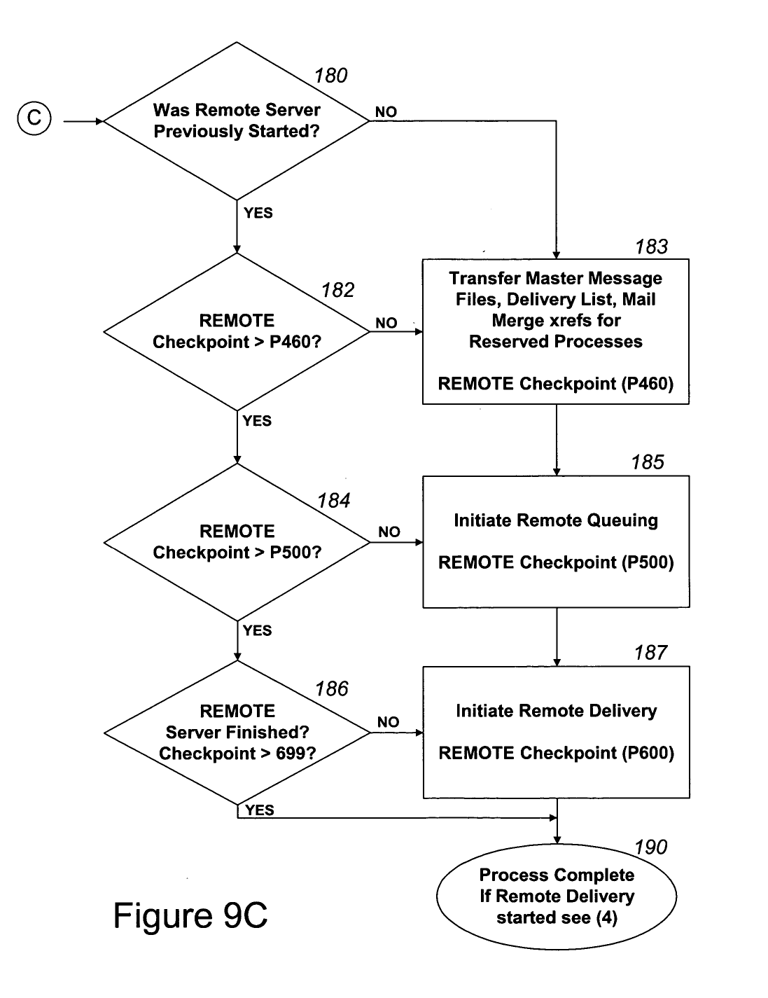

FIG. 9A illustrates a portion of the message sender process. In step 140 the system determines whether the system has previously processed the message. If the message has been previously processed, in step 142 the system reviews the checkpoint file. In step 143 if the message has not been processed before, the system moves data files to the processing directory and saves checkpoint as p 100. In steps 144, 146, 148, 150 the system verifies the current checkpoint value. In step 145, the system updates message archives, creates AOL and multipart/alternative masters and saves checkpoint p 200. In step 147 system updates message history and saves checkpoint P-300. In step 149 the system creates delivery lists and mail merge cross references and thereafter saves checkpoint P. 400. In step 151 system determines simultaneous processes needed based on license, list size and account parameters. In step 152 the system produces delivery lists according to simultaneous processes or delivery resources available to the system. Specifically, this is based on the availability of the B servers.

FIG. 9 B illustrates subsequent processing by each of the deliver or B servers. Block 160 indicates that each delivery server performs the subsequent steps. First, in step 162 the system determines whether or not the system has reserved processes on this particular server previously. In step 164 the system determines the delivery status from the delivery server. Then in step 166 the system determines whether they remote delivery server is running. If the remote delivery server is running then system determines whether more servers need to be checked in step 168. In step 170 the system determines whether it is time to send a delivery report. If it is time to send a delivery report then in step 172 the system sends the required report. In step 174 the system determines whether delivery is complete. If it is not complete, the system determines whether the remote server has aborted delivery. If delivery is complete the system then saves checkpoint as P. 699 in step 176: Thereafter, in step 178 the system deletes the message from the pending message queue.

Steps 163, 165, 166 and 167 are directed to reserving processes on remote servers. In step 163 the system determines whether all necessary processes have been reserved. If all processes have not been reserved, then in step 165 the system determines whether processes can be reserved on this server. If processes can be reserved then the system reserves processes in step 166. Thereafter, in step 167 the system creates a forked process and launches remote delivery.

FIG. 9 C illustrates further processing by the system. In step 180 the system determines whether the particular remote server was previously started. If this particular server was previously started by the system then in step 182 the system verifies whether remote checkpoint is greater than P. 460. Remaining steps 184 and 186 also relate to verification of the current remote checkpoint value. As shown in step 186, if checkpoint is 699, then the process is complete as shown in subsequent step 190. In step 183 the system transfers master message files delivery lists, mail merge and cross references for reserved processes. Remote checkpoint is set to P. 460. In step 185 the system initiates remote queuing and sets remote checkpoint to P. 500. In step 187, system initiates remote delivery and sets checkpoint to P. 600.

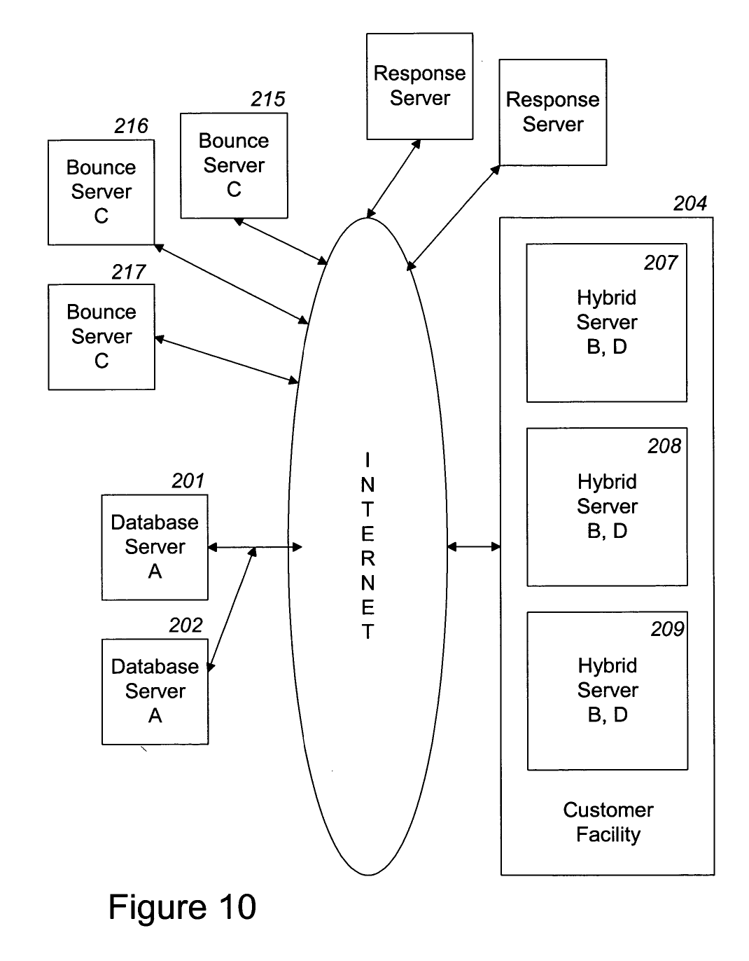

FIG. 10 illustrates yet another alternate preferred exemplary

embodiment of the present invention. In accordance with this alternate preferred exemplary embodiment, the system desirably employs one or more hybrid servers which include the capability of the delivery or class B servers and are designated in FIG. 10 as 207, 208, 209. Additionally, the hybrid servers 207, 208, 209 include the capability of subscribe/remove servers D. These hybrid severs accept and forward bounced mail to the bounce severs C—215, 216, 217. Additionally, they act as HTTP proxy servers for the response servers and they forward HTTP requests and responses. Response processing that is handled by these response servers include, for example, those tasks as described in my co-pending application Ser. No. 10/171,720, titled Systems And Methods For Monitoring Events Associated With Transmitted Electronic Mail Messages, filed on Jun. 14, 2002, which is incorporated herein by reference.

The mail forwarding mechanism used by the hybrid server may be one of many available standard electronic mail software programs, provided it can be configured to ensure that any mail delivered to recipients (as opposed to system servers) is stripped of information identifying the electronic mail delivery service, and instead includes only the hybrid server as the origin of the mail. The HTTP proxy used also may be one of many available standard HTTP web or proxy servers, again configured in such a way as to identify the hybrid server as the destination and origination of HTTP requests and responses respectively. Such configurations are relatively common.

In accordance with this alternate embodiment, the hybrid delivery servers 207, 208, 209 are preferably physically located at a customer facility 204 or are otherwise separated from the remaining system operations and preferably are under the direct control and responsibility of a customer desiring to send substantial numbers of electronic mail messages.

The remaining servers used in performing the overall delivery system operations are desirably located at some other distant location and preferably remain under the custody and control of the electronic mail delivery service. This alternate preferred embodiment provides several advantages over the embodiments described above. First, this physical arrangement eliminates a very significant workload and obligation that was previously placed upon the entity performing the overall mail delivery operation. In the embodiments described previously, when the electronic mail delivery service had the obligation of maintaining the actual delivery servers, the electronic mail delivery service was also obligated to maintain relationships with ISPs providing internet connectivity and/or e-mail service for a customer's recipients. The electronic mail delivery service was also required to ensure that the requisite bandwidth for effecting delivery in a reasonable amount of time was available.

Additionally, the mail delivery service was also required to deal directly with the ISPs for issues such as complaint handling, blocking resolution and/or white listing issues. Furthermore, the mail delivery service was forced to ensure the compliance of all of its customers with the policies of its various upstream internet connectivity providers. These obligations can be very substantial especially for a mail delivery service with a substantial clientele and a significant message volume.

In accordance with this preferred alternate exemplary embodiment, the customer site or facility 204, containing the hybrid servers 207, 208, 209, preferably has a dedicated ISP relationship wherein the customer is responsible for acquiring the internet service provider and paying any fees associated therewith as well as for identifying and complying with the internet service provider's acceptable use policies.

Furthermore, the customer is required to deal directly with the ISP's for issues such as white listing, complaint handling and block resolution. Those skilled in the art will appreciate that it is common that the hybrid servers be physically located at a 3rd party co-location facility. However, the physical location of the hybrid servers is less important than ensuring that the customer maintains responsibility for the internet connection of the hybrid servers. Furthermore, the primary importance associated with this alternate embodiment is that the servers which interface with the end recipients are associated directly with the customer rather than the mail delivery service.

This is important so that the addresses and links for tracking all point back to the customer. As a result, all servers with recipient interfaces must be on networks registered to, rented, or leased by the customer. The customer thus takes full responsibility for all mail that is sent on behalf of the customer. The actual physical location of the server is of minimal importance For example, even in this arrangement it remains possible to maintain the hybrid servers at some other location provided that the entity seeking message delivery has made the appropriate arrangements with an ISP or other third party for the initial transmission or transfer of the electronic mail messages.

Another further advantage of this alternate design is that the high volume and resultant corresponding tremendous bandwidth requirements due to the aggregation of numerous high-volume electronic mail customers has largely been eliminated because these messaging requirements have been distributed throughout a plurality of ISP's due to the fact that individual clients are now responsible for maintaining their own ISP relationships and the physical interconnection to the internet through ISP's hardware In accordance with this preferred exemplary embodiment, the database servers 201, 202 remain under control of the electronic mail delivery service and are physically separated from the customer site or third party co-location facility 204 at which the hybrid servers 207, 208, 209 may be located. Similarly, the bounce servers 215, 216, 217 and response servers also remain under the control of the electronic mail delivery service and are preferably physically separated from the actual customer location 204. In this preferred exemplary embodiment, the mail delivery service preferably maintains custody and control of the servers other than the hybrid servers, while the customer preferably maintains custody and control of the hybrid servers. FIG. 10 illustrates this preferred exemplary embodiment. Although this is one possible configuration, it should be recognized that the preferred configuration is to have all external interfaces on a customer's network.

In order to eliminate ISP issues for mass electronic mail delivery service providers, it is especially preferred that any functionality to which a customer's recipients will be exposed should be preferably located within the customer's network or on a network which is otherwise associated with the mail delivery customer. For example, this functionality i.e., response servers, as well as inbound or bounce servers should be either located on a hybrid server at the customer's location or the hybrid servers at the customer's location will be used as a proxy/or forwarding interface in order to remove any association with the electronic mail service provider.

Alternatively, a third party may maintain custody and control of the hybrid servers, and provide for the servers' internet connectivity. In this alternative embodiment, such a third party takes responsibility for the aforementioned issues associated with the hybrid servers.

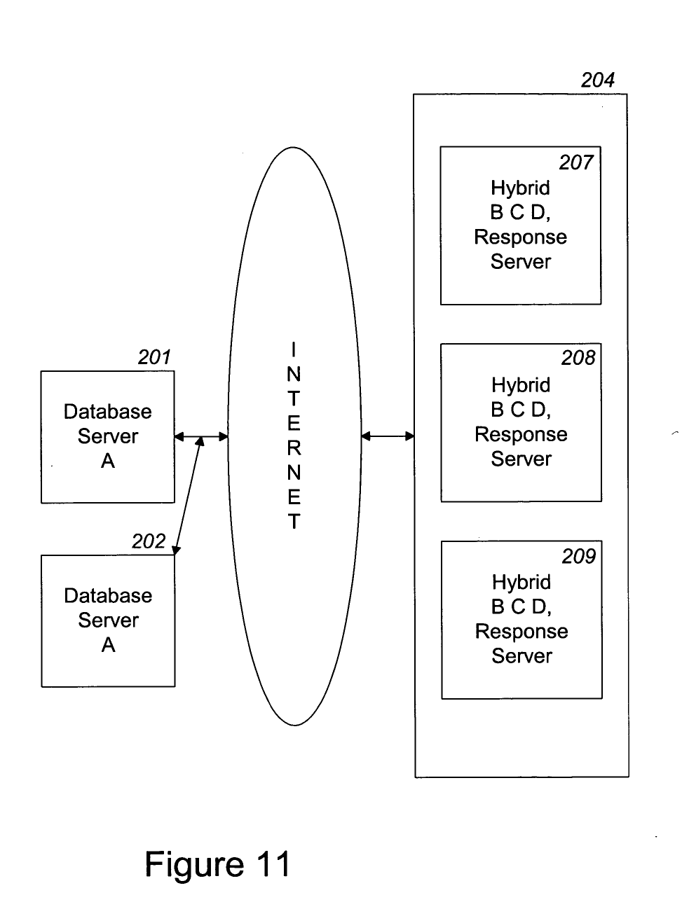

FIG. 11 illustrates yet another alternate embodiment wherein the hybrid servers also incorporate the responsibilities for processing bounced messages and response tracking. As shown in FIG. 11, the customer facility includes one or more hybrid servers 207, 208, 209. The hybrid servers 207, 208, 209 are each independently capable of performing mail delivery (B); the processing of inbound mail (the D servers); processing of bounced mail (C); and response processing. These hybrid servers are more capable and also include the ability to process bounced messages. Therefore, unlike the embodiment of FIG. 10, these hybrid severs need not forward bounced mail to additional servers because they handle the internal processing of these messages. Likewise, these hybrid servers include the ability to process responses, and therefore do not require HTTP proxy capability for response traffic.

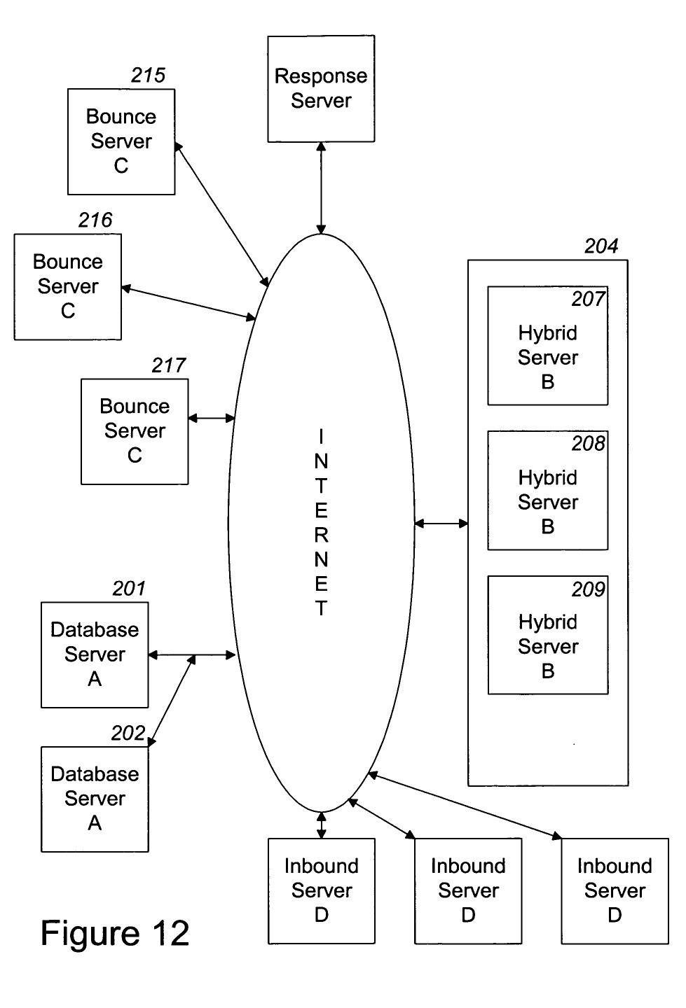

FIG. 12 illustrates yet another alternate embodiment of the present invention. As shown in FIG. 12, the customer facility maintains one or more hybrid servers 207, 208, 209. The hybrid servers 207, 208, 209 are only responsible for performing mail delivery operations and acting as a proxy or forwarding interface for other banks of servers. These hybrid servers forward any bounced mail to one or more bounce servers or class C servers 215, 216, 217. Additionally, the hybrid servers 207, 208, 209 forward any inbound mail and act as HTTP proxies for the inbound or D servers 220, 221, 222. Furthermore, the hybrid servers 207, 208, 209 act as HTTP proxies for the response servers. In this embodiment, the database servers 201 and 202 are also distinct servers which remain under the control of the electronic mail delivery service.

It is to be recognized by those skilled in the art that the foregoing flow diagrams represent a single exemplary embodiment of the system. It should be apparent that other implementations may be readily accomplished. Specifically, for example, a greater or lesser number of checkpoints may be utilized by the system in order to verify completion of various stages in the overall process. It will also be appreciated by those skilled in the art that numerous modifications and alterations of the systems and methods set forth herein are contemplated but will nevertheless fall within the spirit and scope of the present invention as defined in the attached claims.

1. A method for transmitting an electronic mail (email) messages comprising the steps of:
providing a plurality of email addresses;
transmitting separate sub sets of the plurality of email addresses to a plurality of mail transfer agents (MTAs) wherein the MTAs can be geographically distant from a source of the subset transmission; and
transmitting the email message with the MTAs to addresses contained in the subsets.

2. The method of claim 1, further comprising a step of verifying that the email message has been sent to each recipient set forth in the plurality of email addresses.

3. The method of claim 1, further comprising a step of partitioning the plurality of email addresses into the subsets.

4. The method of claim 1, further comprising a step of designating separate receive servers for receiving any bounced messages and/or replies.

5. The method of claim 1, further comprising a step of reviewing mail transmission progress information provided by the MTAs.

6. The method of claim 5, further comprising a step of restarting any stalled process identified in said step of reviewing the mail transmission progress.

7. The method of claim 1, further comprising a step of automatically updating the plurality of email addresses based on returned mail information.

8. The method of claim 1 wherein:
a subset transmitted to a first MTA contains email addresses for the network to which the first MTA belongs.

9. The method of claim 1 wherein:
a subset transmitted to a first MTA contains email addresses to which the first MTA can deliver email more efficiently than other MTAs.

10. The method of claim 1, further comprising:
personalizing the email message for each email address in the plurality of email addresses.

11. A method for transmitting an electronic mail (email) message to a plurality of email addresses, comprising:
partitioning the plurality of email addresses into subsets based on predefined criteria;
allocating mail transmission resources on a plurality of mail transfer agents (MTAs);
distributing the subsets to the plurality of MTAs wherein each subset is distributed to at most one MTA; and
transmitting the email message with the MTAs to addresses contained in the subsets.

12. The method of claim 11 wherein:
the predefined criteria can include at least one of: 1) available mail transmission resources; 2) performance characteristics of the plurality of MTAs; and 3) email address.

13. The method of claim 11, further comprising:
verifying that the email message has been sent to each recipient set forth in the plurality of email addresses.

14. The method of claim 11, further comprising:
designating separate receive servers for receiving any bounced messages or replies.

15. The method of claim 11, further comprising:
reviewing mail transmission progress information provided by the MTAs.

16. The method of claim 15, further comprising:
restarting any stalled process identified in said step of reviewing the mail transmission progress.

17. The method of claim 11, further comprising:
automatically updating the plurality of email addresses based on returned mail information.

18. The method of claim 11 wherein:
a subset transmitted to a given MTA contains email addresses for the network to which the given MTA belongs.

19. The method of claim 11 wherein:
a subset transmitted to a given MTA contains email addresses to which the given MTA can deliver email more efficiently than other MTAs.

20. The method of claim 11, further comprising:
personalizing the email message for each email address in the plurality of email addresses.

21. A system comprising:
means for generating a plurality of email addresses;
means for transmitting separate subsets of the plurality of email addresses to a plurality of mail transfer agents (MTAs), wherein the plurality of MTAs can be physically distant from a source of the subset transmission; and
means for transmitting an email message with the MTAs to addresses contained in the subsets.

22. A system for delivering an electronic mail (email) message to a set of email addresses, comprising:
a message sender process operable to manage mail delivery;
at least one mail transfer agent (MTA) process operable to deliver email;
a return process operable to accept bounced mail;
an inbound process operable to handle requests; and
wherein the processes can execute on one or more computing devices connected by a computer network.

23. The system of claim 22 wherein:
the message sender process is operable to partition the set of email addresses into subsets based on predefined criteria.

24. The system of claim 22 wherein:
the message sender process is operable to determine mail transfer resources needed on the at least one MTA.

25. The system of claim 24 wherein:
the determination of resources is based on a target delivery time and/or a number recipients.

26. The system of claim 22 wherein:
the message sender process is operable to monitor the progress of mail delivery; and
wherein the message sender process is operable to restart any stalled process.

27. The system of claim 22 wherein:
the message sender process is operable to partition the set of email addresses into subsets based on predefined criteria;

28. The system of claim 27 wherein:
the predefined criteria include at least one of: 1) available mail transmission resources; 2) performance characteristics of the plurality of at least one MTA; and 3) email address.

29. The system of claim 27 wherein:
the message sender process is operable to distribute the subsets to the at least one MTA.

30. The system of claim 22 wherein:
the at least one MTA process is operable to personalize the email message.

31. The system of claim 22 wherein:
the at least one MTA process can be distributed according to at least one of: 1) geography; and 2) network topology.

32. The system of claim 22 wherein:
the at least one MTA process is operable to acquire a subset of the email addresses from the message sender process.

33. The system of claim 22 wherein:
the return process is operable to communicate information pertaining to bounced email to the message sender process.

34. The system of claim 22 wherein:
the inbound process is operable to handle requests to modify the set of email addresses.

35. A machine readable medium having instructions stored thereon that when executed by a processor cause a system to:
partition a plurality of email addresses into subsets based on predefined criteria;
allocate mail transmission resources on a plurality of mail transfer agents (MTAs);
distribute the subsets to the MTAs wherein each subset is distributed to at most one MTA; and
transmit the email message with the MTAs to addresses contained in the subsets.

36. The machine readable medium of claim 35 wherein:
the predefined criteria include at least one of: 1) available mail transmission resources; 2) performance characteristics of the plurality of MTAs; and 3) email address.

37. The machine readable medium of claim 35, further comprising instructions that when executed cause the system to:
verify that the email message has been sent to each recipient set forth in the plurality of email addresses.

38. The machine readable medium of claim 35, further comprising instructions that when executed cause the system to:
designate separate receive servers for receiving any bounced messages and/or replies.

39. The machine readable medium of claim 35, further comprising instructions that when executed cause the system to:
review mail transmission progress information provided by the MTAs.

40. The machine readable medium of claim 39, further comprising instructions that when executed cause the system to:
restart any stalled process identified in said step of reviewing the mail transmission progress.

41. The machine readable medium of claim 35, further comprising instructions that when executed cause the system to:
update a primary mailing list based on returned mail information.

42. The machine readable medium of claim 35 wherein:
a subset transmitted to a first MTA contains email addresses for the network to which the first MTA belongs.

43. The machine readable medium of claim 35 wherein:
wherein a subset transmitted to a first MTA contains email addresses to which the first MTA can deliver email more efficiently than other MTAs.

44. The machine readable medium of claim 35, further comprising instructions that when executed cause the system to:
personalize the email message for each email address.

45. A computer data signal embodied in a transmission medium, comprising:
a code segment including instructions to partition a plurality of email addresses into subsets based on predefined criteria;
a code segment including instructions to allocate mail transmission resources on a plurality of mail transfer agents (MTAs);
a code segment including instructions to distribute the subsets to the plurality of MTAs wherein each subset is distributed to at most one MTA; and
a code segment including instructions to transmit the email message with the MTAs to addresses contained in the subsets.
